(19) United States
(12) Patent Application Publication
(10) Pub. No.: US 2025/0258757 A1
(43) Pub. Date: Aug. 14, 2025

(54) INFORMATION PROCESSING APPARATUS, INFORMATION PROCESSING METHOD, AND COMPUTER PROGRAM PRODUCT

(71) Applicant: KABUSHIKI KAISHA TOSHIBA, Tokyo (JP)

(72) Inventor: Hiroshi KAWAZOE, Fujisawa Kanagawa (JP)

(73) Assignee: KABUSHIKI KAISHA TOSHIBA, Tokyo (JP)

(21) Appl. No.: 19/042,994

(22) Filed: Jan. 31, 2025

(30) Foreign Application Priority Data
Feb. 8, 2024 (JP) 2024-017691

(51) Int. Cl. G06F 11/3668

(52) U.S. Cl. CPC G06F 11/3684; G06F 11/3688

(57) ABSTRACT

According to an embodiment, an information processing apparatus includes a communication interface, and a processor. The communication interface is configured to transmit an inference request of a method of calling an application programming interface (API) included in an API specification, to a specification interpretation device that interprets the API specification by natural language processing, and receive a response indicating the method of calling the API included in the API specification from the specification interpretation device. The processor is configured to determine whether or not the method of calling the API indicated by the response is correct, and generate a test scenario based on the method of calling the API indicated by the response if the method of calling the API indicated by the response is correct.

### CROSS-REFERENCE TO RELATED APPLICATIONS

This application is based upon and claims the benefit of priority from Japanese Patent Application No. 2024-017691, filed on Feb. 8, 2024; the entire contents of which are incorporated herein by reference.

### FIELD

Embodiments described herein relate generally to an information processing apparatus, an information processing method, and a computer program product.

### BACKGROUND

Recently, in application programming interface (API) development, importance of a technique for automatically generating a test scenario is increasing. The test scenario is a series of procedures and test cases for checking whether the API functions as expected. When a test scenario is manually created, there is a case where completeness, accuracy, and the like are insufficient due to human judgment, mistake, omission, or the like. In particular, in a case where a large-scale API or a specification changes frequently, manual updating is very laborious, and thus, needs for automation are increasing.

### BRIEF DESCRIPTION OF THE DRAWINGS

FIG. 1 is a diagram illustrating an example of a functional configuration of an information processing apparatus according to a first embodiment;

FIG. 2 is a diagram illustrating Example 1 of an API specification according to the first embodiment;

FIG. 3 is a diagram illustrating Example 1 of a response to a prompt according to the first embodiment;

FIG. 4 is a diagram illustrating Example 2 of a response to a prompt according to the first embodiment;

FIG. 5 is a diagram illustrating Example 3 of a response to a prompt according to the first embodiment;

FIG. 6A is a diagram illustrating an example of an HTTP request according to the first embodiment;

FIG. 6B is a diagram illustrating an example of a response to the HTTP request in FIG. 6A;

FIG. 7 is a diagram illustrating Example 1 of a series of HTTP requests and responses according to the first embodiment;

FIG. 8 is a diagram illustrating Example 2 of a series of HTTP requests and responses according to the first embodiment;

FIG. 9 is a diagram illustrating Example 3 of a series of HTTP requests and responses according to the first embodiment;

FIG. 10A is a diagram illustrating Example 1 of a method of calling an API to be a normal system according to the first embodiment;

FIG. 10B is a diagram illustrating Example 2 of a method of calling an API to be a normal system according to the first embodiment;

FIG. 10C is a diagram illustrating Example 3 of a method of calling an API to be a normal system according to the first embodiment;

FIG. 11A is a diagram illustrating Example 1 of a test scenario of an abnormal system according to the first embodiment;

FIG. 11B is a diagram illustrating Example 2 of a test scenario of an abnormal system according to the first embodiment;

FIG. 12A is a diagram illustrating Example 3 of a test scenario of an abnormal system according to the first embodiment;

FIG. 12B is a diagram illustrating Example 4 of a test scenario of an abnormal system according to the first embodiment;

FIG. 13 is a diagram illustrating Example 2 of an API specification according to the first embodiment;

FIG. 14 is a diagram illustrating Example 4 of a response to a prompt according to the first embodiment;

FIG. 15 is a diagram illustrating Example 5 of a test scenario of an abnormal system according to the first embodiment;

FIG. 16 is a flowchart illustrating an example of an information processing method according to the first embodiment;

FIG. 17 is a diagram illustrating an example of a functional configuration of an information processing apparatus according to a second embodiment;

FIG. 18 is a diagram illustrating an example of an API specification according to the second embodiment;

FIG. 19A is a diagram illustrating an example of a response to a prompt according to the second embodiment;

FIG. 19B is a diagram illustrating an example of a response to a prompt according to the second embodiment;

FIG. 20 is a flowchart illustrating an example of an information processing method according to the first embodiment; and

FIG. 21 is a diagram illustrating an example of a hardware configuration of an information processing apparatus according to the first and second embodiments.

### DETAILED DESCRIPTION

According to an embodiment, an information processing apparatus includes a communication interface, and a processor. The communication interface is configured to transmit an inference request of a method of calling an application programming interface (API) included in an API specification, to a specification interpretation device that interprets the API specification by natural language processing, and receive a response indicating the method of calling the API included in the API specification from the specification interpretation device. The processor is configured to determine whether or not the method of calling the API indicated by the response is correct, and generates a test scenario based on the method of calling the API indicated by the response if the method of calling the API indicated by the response is correct.

Hereinafter, embodiments of an information processing apparatus, an information processing method, and a program will be described in detail with reference to the accompanying drawings.

Recently, in particular, a description specification of an API specification called OpenAPI (formerly Swagger) has become widespread, and details such as an API endpoint, a parameter, and a response can be structured and described. This structured information is well suited as a basis for automated test case generation.

On the other hand, there is a specification that cannot be expressed by the expressive power of OpenAPI. For example, examples include dependency between a plurality of API (for example, a response of API-A is used for input of API-B), a complicated parameter specification method, and the like. These specifications may be freely described in the OpenAPI description column, or the reader may have to imagine from the endpoint name, parameter name, or the like.

Therein, the incorporation of a natural language processing technology represented by generative AI such as ChatGPT (registered trademark) is becoming a field of view. It can be expected to analyze the content of the free description and specify an API specification that cannot be expressed by OpenAPI. Furthermore, generative AI is expected to be able to interpret API specifications based on current best practices and conventions for API design.

### First Embodiment

In the first embodiment, an information processing apparatus that automatically generates a test scenario from description contents of an API specification and inputs and executes test patterns of various normal systems and abnormal systems to an API execution apparatus under development to improve API quality will be described.

The first embodiment is an example of generating a test scenario for checking whether or not a response when various inputs are given is appropriate for an API execution apparatus that has been developed by a user (for example, API developers) and at least correctly implemented normal system processing. In the first embodiment, the processing of the normal system can be performed even in a stage where the processing of the normal system is implemented and the processing of the abnormal system is not yet implemented.

In the test using the test scenario of the first embodiment, it is checked that a status code indicating success or failure is returned. In the test of the processing of the normal system, it is checked that a status code indicating success is returned. In the test of the processing of the abnormal system, it is checked that a status code indicating failure is returned.

### Example of Functional Configuration

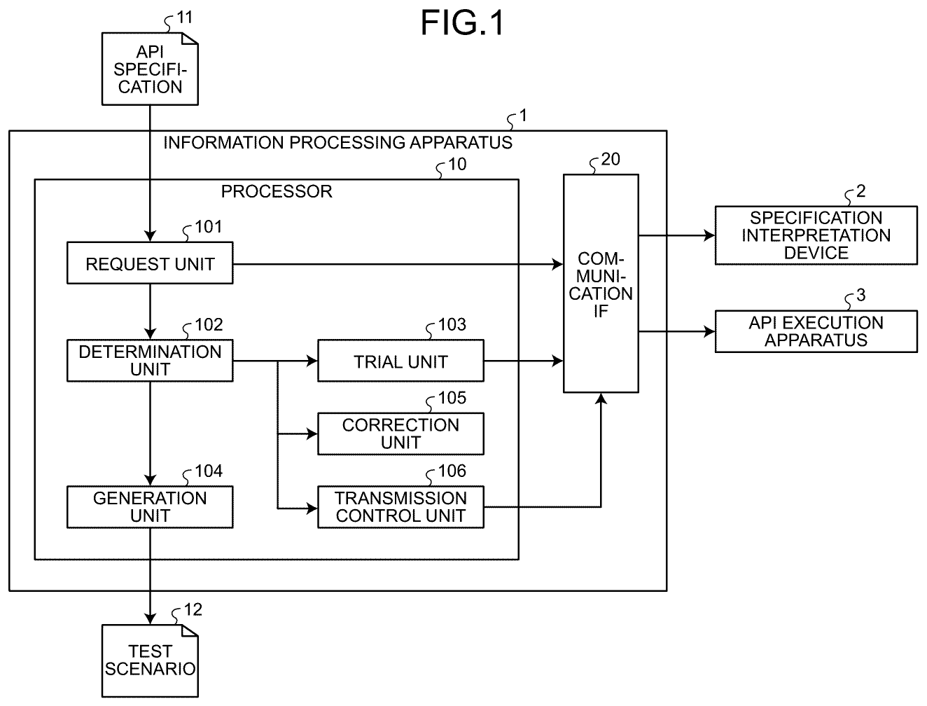

FIG. 1 is a diagram illustrating an example of a functional configuration of an information processing apparatus 1 according to a first embodiment. The information processing apparatus 1 according to the first embodiment includes a processor 10 and a communication interface (IF) 20.

The processor 10 generates a test scenario 12 based on, for example, an input of an API specification 11 from a user of an organization that creates the API.

The processor 10 is implemented by at least one processing device, and executes processing of the information processing apparatus 1. This processing device includes, for example, a control device and an arithmetic device, and is implemented by an analog or digital circuit or the like. The processing device may be a central processing unit (CPU), or may be a general-purpose processor, a microprocessor, a digital signal processor (DSP), an application specific integrated circuit (ASIC), a field-programmable gate array (FPGA), or a combination thereof.

The processor 10 includes a request unit 101, a determination unit 102, a trial unit 103, a generation unit 104, a correction unit 105, and a transmission control unit 106.

The request unit 101 receives an input of the API specification 11, and requests a specification interpretation device 2 via the communication IF 20 to perform inference of the method of calling the API included in the specification of each API. The inference of the method of calling the API in the first embodiment means that “the method of calling a series of APIs from which a success status code is obtained” is inferred in each API. The inference request of the method of calling the API included in the API specification may include a presentation request of a plurality of candidates indicating the method of calling the API. Whether or not the method of calling the API obtained by the inference by the specification interpretation device 2 is correct is determined by the determination unit 102.

The determination unit 102 determines whether the method of calling the API obtained by the inference by the specification interpretation device 2 is correct. For example, in a case where a successful status code is included in the response to the API request, the determination unit 102 determines that the method of calling the API is correct.

The trial unit 103 tries the API request by transmitting the API request to an API execution apparatus 3 via the communication IF 20.

The generation unit 104 generates a test scenario 12 based on the method of calling the API determined to be correct by the determination unit 102.

The correction unit 105 corrects the method of calling the API based on an instruction from the user. For example, the correction unit 105 displays information indicating the method of calling the API determined to be correct on the display device, and corrects the method of calling the API based on the correction information input by the user.

The transmission control unit 106 transmits learning data including information indicating the method of calling the API determined to be correct to the specification interpretation device 2 via the communication IF 20.

The communication IF 20 communicates with other devices such as the specification interpretation device 2 and the API execution apparatus 3. For example, the communication IF 20 receives a response to the inference request of the method of calling the API included in the API specification from the specification interpretation device 2, and transmits at least one API request to the API execution apparatus 3 based on the method of calling the API indicated by the response.

The specification interpretation device 2 analyzes the contents of the API specification 11 and infers the method of calling the API. In the first embodiment, the specification interpretation device 2 is, for example, a server device of ChatGPT (registered trademark).

The API execution apparatus 3 is a server device developed by the user (for example, API developers) of the first embodiment based on the API specification 11. Based on the input of the request, an output is generated and returned as a response. It is assumed that at least the normal system processing is correctly implemented in the API execution apparatus 3.

Next, processing performed by the information processing apparatus 1 according to the first embodiment will be described. The request unit 101 receives an input of the API specification 11 in response to an operation input by the user.

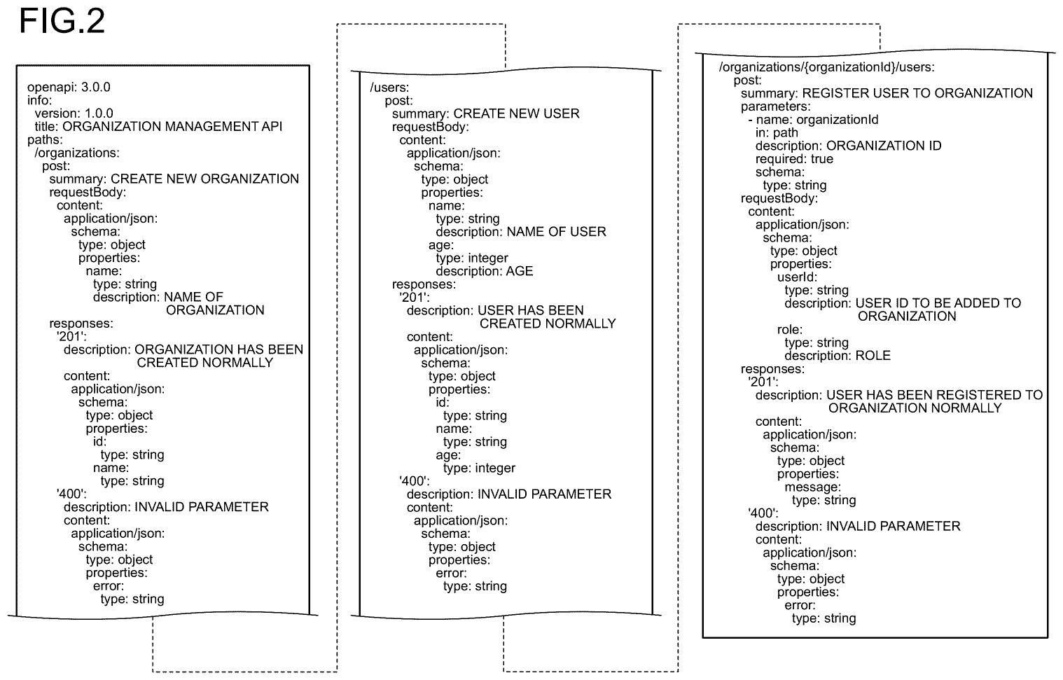

FIG. 2 is a diagram illustrating Example 1 of the API specification 11 according to the first embodiment. In the example of FIG. 2, the following information is written as a specification in the OpenAPI format for three APIs.

### Specification Example

```
  1. Create new organization
  endpoint: /organizations
  method: POST
  request body:
  name (character string): The name of the organization.
  response:
  status:
  201 Created
  400 Bad Request
  body:
  id (character string): Unique identifier of the
organization.
  name (character string): The name of the organization.
  2. Create new user
  Endpoint: /users
  method: POST
  request body:
  title (character string): User's name.
  age (integer): age.
  response:
  status:
  201 Created
  400 Bad Request
  body:
  id (character string): Unique identifier of the user.
  name (character string): User's name.
  age (integer): age.
  3. Register a user to an organization
  endpoint: /organizations/{organizationId}/users
  method: POST
  parameters:
  organizationId (character string-path): ID of the
organization to which the user is added.
  request body:
  userId (character string): ID of the user to be added
to the organization.
  response:
  status:
  201 Created
  400 Bad Request
  ------------
```

Next, the usage intended by the creator of the API specification is as follows.

### Usage Example

A first API (left in FIG. 2) is an API for creating a new organization./organizations sends a request to the endpoint by a POST method. In the request body, the name of the organization to be newly created is specified as name in the JSON format.

### Request Example

{
“name”: “Sales department”
}

When the processing is normally performed, information of the newly created organization is returned as a response together with a status code 201.

### Response Example

{
“id”: “abc123”,
“name”: “Sales department”
}

If an inappropriate parameter is specified, a status code 400 is returned.

A second API (center in FIG. 2) is an API for creating a new user./users sends a request to the endpoint by a POST method. In the request body, the name of the user to be newly created is specified as name, and the age is specified as age in the JSON format.

### Request Example

{
“name”: “John Smith”,
“age”: 30
}

When the processing is normally performed, information of the newly created user is returned as a response together with the status code 201.

### Response Example

{
“id”: “def456”,
“name”: “John Smith”,
“age”: 30
}

If an inappropriate parameter is specified, the status code 400 is returned.

A third API (right in FIG. 2) is an API for registering a user in an organization.

/organizations/{organizationId}/users sends a request to the endpoint by a POST method. Here, {organizationId} specifies an ID of an organization to which the user is desired to be added. In the request body, the ID of the user to be added to the organization is specified as userId, and the role of the user in the organization is specified as role.

### Example

{
“userId”: “def456”,
“role”: “manager”,
}

When processed normally, the status code 201 is returned.

### Response Example

```
  {
  “message”: “The user has been registered with the
organization normally. ”
  }
```

If an inappropriate parameter is specified, the status code 400 is returned.

When receiving the API specification 11 as an input, the processor 10 generates the test scenario 12 by the following procedure. In the test scenario 12, various inputs are given to the parameters of each API, and it is checked that an appropriate status code is obtained.

First, the request unit 101 analyzes the API specification 11 and extracts an endpoint, a parameter, a response, and the like of each API defined in the API specification 11. Next, when performing the API test, the request unit 101 requests the specification interpretation device 2 to infer the method of calling the API in order to grasp what value should be designated for each parameter in order to perform the normal system test.

The following is an example of a prompt generated by the request unit 101. This prompt is a prompt asking the test scenario 12 of the normal system (the method of calling the API from which the success status code is obtained) for the first API (POST/organizations) among the three examples of FIG. 2.

### Example of Prompt

The following is a specification of Web API described in OpenAPI format. Regarding the following API of interest, estimate at least five methods of “the method of calling a series of APIs” by which a status code of success can be obtained from this API, and output them strictly following the following constraint conditions.

```
  # API of interest
  POST /organizations
  # constraint condition
  - never output any text other than JSON.
  - output in JSON format according to the following
JSON schema.
  - the last element of each stages corresponds to a
call of the API of interest.
  {
  “$schema”: “http://json-schema.org/draft-04/schema#”,
  “type”: “object”,
  “properties”: {
  “candidates”: {
  “type”: “array”,
  “items”: (
  {
  “type”: “object”,
  “properties”: {
  “stages”: {
  “type”: “array”,
  “items”: (
  {
  “type”: “object”,
  “properties”: {
  “path”: {
  “type”: “string”
  },
  “method”: {
  “type”: “string”
  },
  “params”: {
  “type”: “object”
  }
  },
  “required”: (
  “path”,
  “method”,
  “params”
  )
  }
  )
  }
  },
  “required”: (
  “stages”
  )
  }
  )
  }
  },
  “required”: (
  “candidates”
  )
  }
  - In stages, specify “the method of calling a series
of APIs”. “the method of calling a series of APIs” is an
array of “API calls”. “API call” corresponds to
transmission of a request to the API and reception of a
response, and includes a path (path), a method (method),
and a parameter (param). By calling the APIs in the order
specified in “the method of calling a series of APIs”, it
is expected that the API call of the API of interest
returns a success status code.
  - If it is presumed that the API of interest needs to
call some other API in advance in order to return a status
code of success, describe such an API call in an array of
stages. When the API is called in order from the top of
the array stages, it is expected that the last API call
returns a status code of success. The last element of the
stages must be a call of the API of interest.
  - In a case where it is estimated that the next API
call needs to be performed using the content of the
response to the API call called in advance, write the
dependency in the response. When making a request for API
call of the second element of the stages by using the
element foo of the response to API call of the first
element of the stages, write {{0.foo}} in params.
  - In candidates, specify a plurality of patterns of
API call method candidates for which a status code of
success will be obtained. Priority will be given to those
with a small number of API calls and a high possibility of
obtaining a status code of success at the beginning.
Simple guesses may not provide a status code of success, so
please also mention complex patterns involving multiple API
calls.
  # Web API Specification
  openapi: 3.0.0
  info:
```

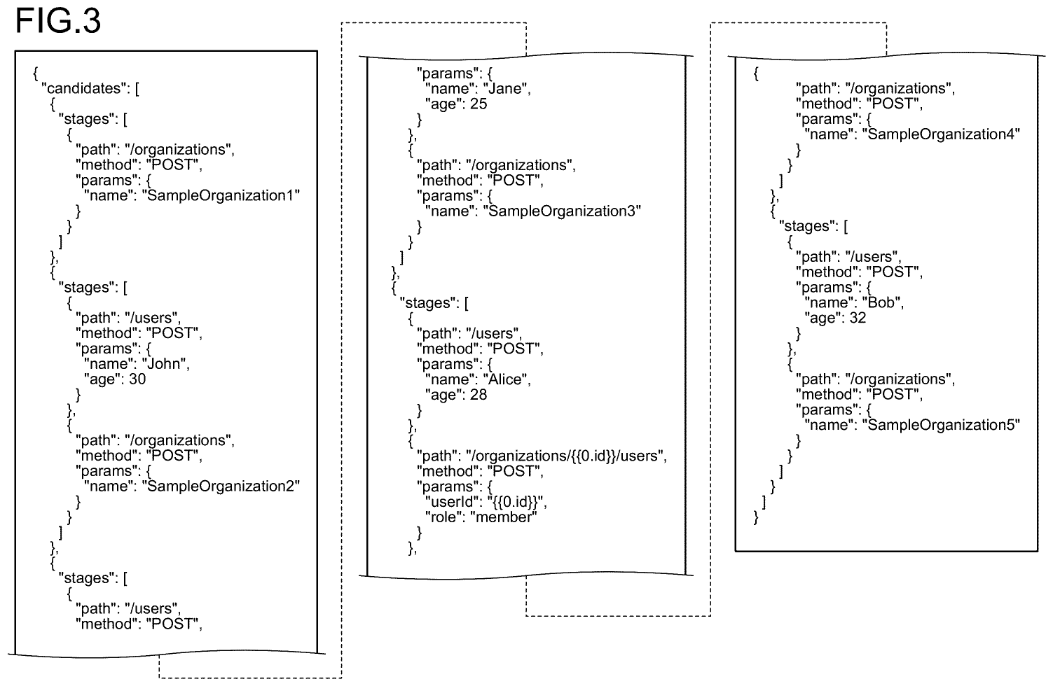

The specification interpretation device 2 returns a response to the above prompt asking a test scenario 12 of the normal system (the method of calling an API from which a status code of success is obtained) to the first API (POST/organizations) in FIG. 2. An example of the response is illustrated in FIG. 3.

FIG. 3 is a diagram illustrating Example 1 of a response to a prompt according to the first embodiment. In the example of FIG. 3, a plurality of candidates for calling a series of APIs are illustrated. Note that, in a case where the response in FIG. 3 is not as expected, the request unit 101 may perform a part or all of the request again.

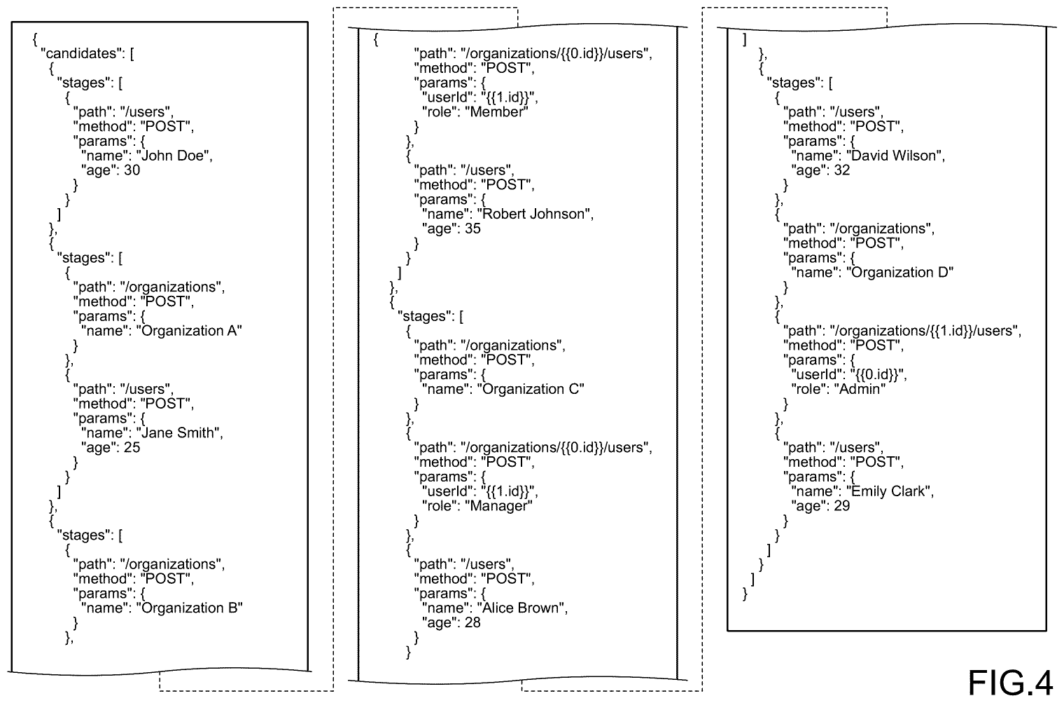

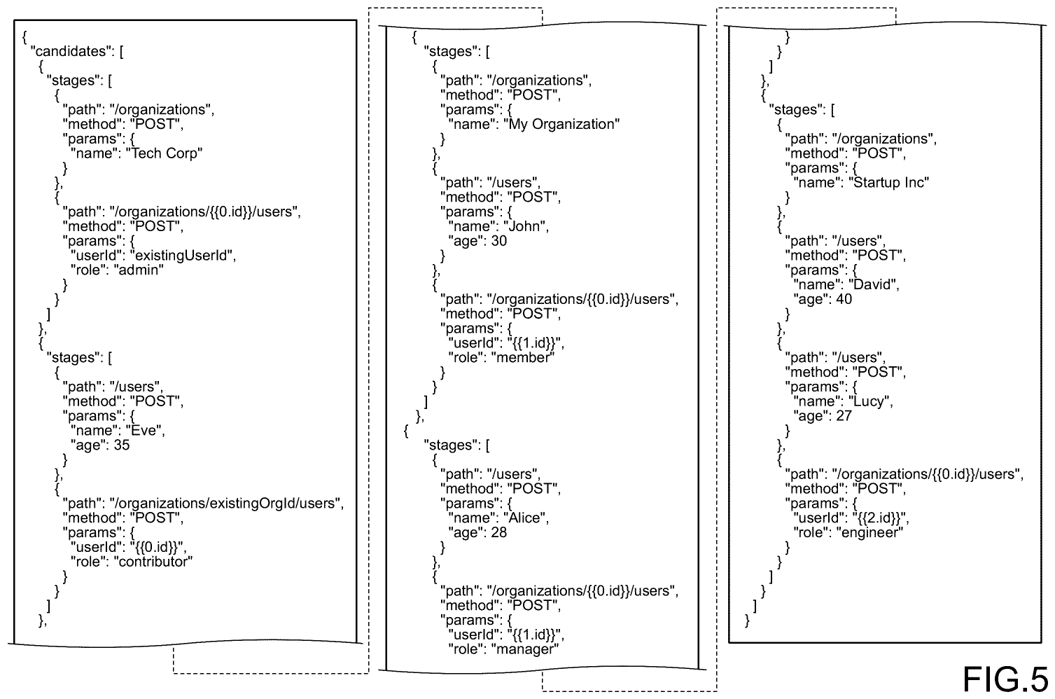

The request unit 101 creates a similar prompt for other APIs (center and right in FIG. 2) and requests the specification interpretation device 2 to do the same. FIG. 4 illustrates a response to the second API (POST/users) in FIG. 2, and FIG. 5 illustrates a response to the third API (POST/organizations/{organizationId}/users) in FIG. 2.

FIG. 4 is a diagram illustrating Example 2 of a response to a prompt according to the first embodiment. FIG. 4 illustrates an example of a response to the above prompt asking the test scenario 12 of the normal system (the method of calling the API from which the status code of success is obtained) with respect to the second API (POST/users) in FIG. 2. In the example of FIG. 4, a plurality of candidates for calling a series of APIs are illustrated.

FIG. 5 is a diagram illustrating Example 3 of a response to a prompt according to the first embodiment. FIG. 5 illustrates an example of a response to the above prompt asking the test scenario 12 of the normal system (the method of calling the API from which the status code of success is obtained) with respect to the third API (POST/organizations/{organizationId}/users) in FIG. 2. In the example of FIG. 5, a plurality of candidates for calling a series of APIs are illustrated.

Note that, in the first embodiment, an individual prompt is created for each API and transmitted to the specification interpretation device 2, but an inference request of a method of calling for all APIs may be written in a single prompt and requested to the specification interpretation device 2 only once.

The request unit 101 transmits the obtained API call method (JSON format) to the determination unit 102, and requests the determination unit to determine whether or not the API call method is a correct API call method. For each API, the determination unit 102 tries candidates for calling a series of APIs in order from the top. For example, in the case of the first API (POST/organizations) in FIG. 2, the first candidate (candidates) is to make the following API call according to FIG. 3.

•Method: POST
•Path: /organizations
•Parameters:
{
“name”: “SampleOrganization1”
}

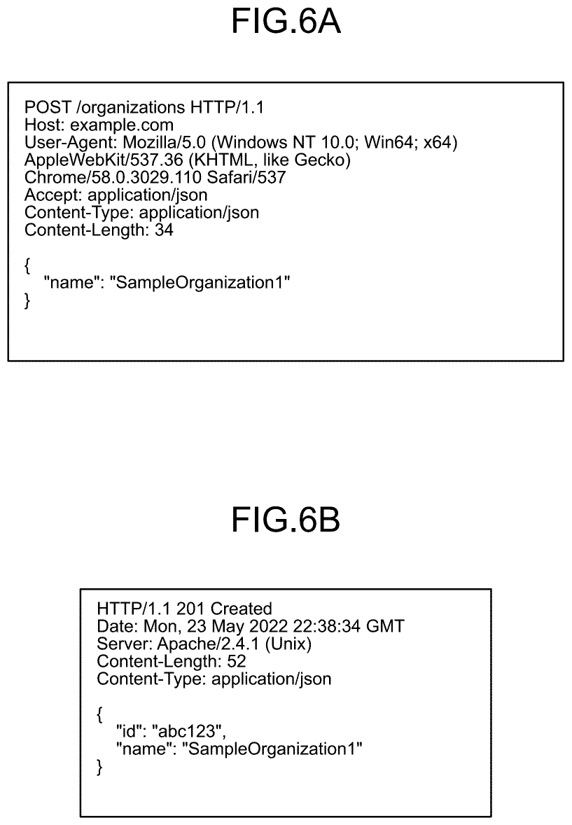

The determination unit 102 requests the trial unit 103 to create and transmit an HTTP request. The trial unit 103 creates an HTTP request in response to the request from the determination unit 102 and sends the HTTP request to the API execution apparatus 3. The API execution apparatus 3 processes the request and returns an HTTP response. Examples of the request and the response are illustrated in FIGS. 6A and 6B.

FIG. 6A is a diagram illustrating an example of an HTTP request according to the first embodiment. FIG. 6B is a diagram illustrating an example of a response to the HTTP request in FIG. 6A. In the case of FIGS. 6A and 6B, the request is successful, and the status code 201 and the details of the resource generated in the response body are returned. The determination unit 102 determines that FIG. 6A is the normal-system API call method based on the fact that the status code of success is obtained. The determination of the specification related to the first API in FIG. 2 ends.

The determination unit 102 also determines the specification of the second API in FIG. 2. Also for the second API, a status code of success is obtained by making the first API call of the candidates in FIG. 4. Therefore, the determination unit 102 determines that the first API call of the candidates in FIG. 4 is a normal-system API call method.

•Method: POST
•Path: /users
•Parameters:
{
“name”: “John Doe”,
“age”: 30
}

Note that, in a case where the status code of success has not been obtained (for example, the status code 400 or the like), the determination unit 102 continues to call the API of the next element of candidates and checks whether or not the status code of success is obtained.

The determination unit 102 also determines the specification of the third API in FIG. 2. According to FIG. 5, the first candidate consists of the following two API calls.

•First time
•Method: POST
•Path: /organizations
•Parameters:
{
“name”: “Tech Corp”
}
•Second time
•Method: POST
•Path: /organizations/{{0.id}/users
•Parameters:
{
“userId”: “existingUserId”,
“role”: “admin”
}

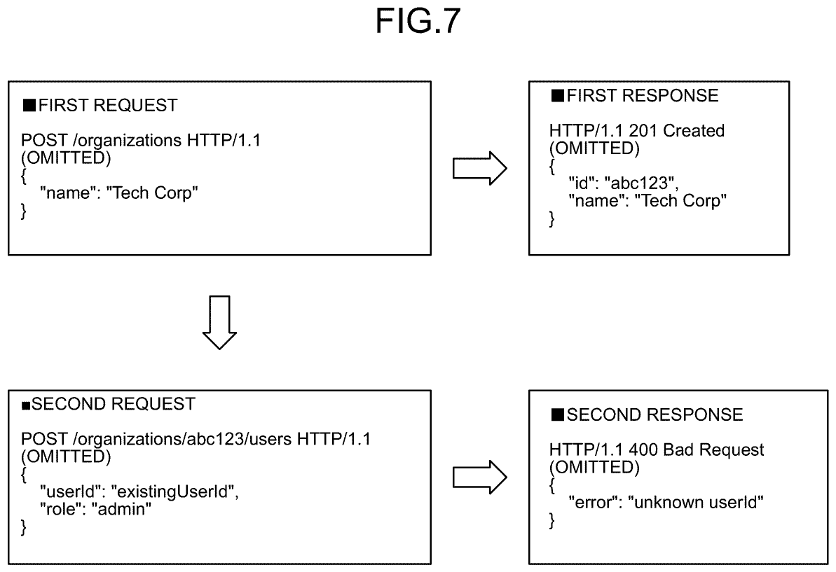

In the second API call, the content of the first response is used as instructed in the prompt. That is, the id portion of the first response is used as the {{0.id}} portion of the path. The determination unit 102 constructs a body part of the second HTTP request from the first response. An example of a series of requests and responses is as illustrated in FIG. 7.

FIG. 7 is a diagram illustrating Example 1 of a series of HTTP requests and responses according to the first embodiment. In the second request, the actual id value (abc123) is used for the {{0.id}} portion of the path. However, the second request fails with a status code 400. The reason is that the character string “existingUserId” specified as the identifier of the user is an identifier that does not exist in the actual system. From this, the determination unit 102 determines that the request in FIG. 7 is not a normal-system API call method, and tries the next candidate in FIG. 5. The next candidate consists of the following two API calls:

•First time
•Method: POST
•Path: /users
•Parameters:
{
“name”: “Eve”,
“age”: 35
}
•Second time
•Method: POST
•Path: organizations/existingOrgId/users
•Parameters:
{
“userId”: “{{0.id}}”,
“role”: “contributor”
}

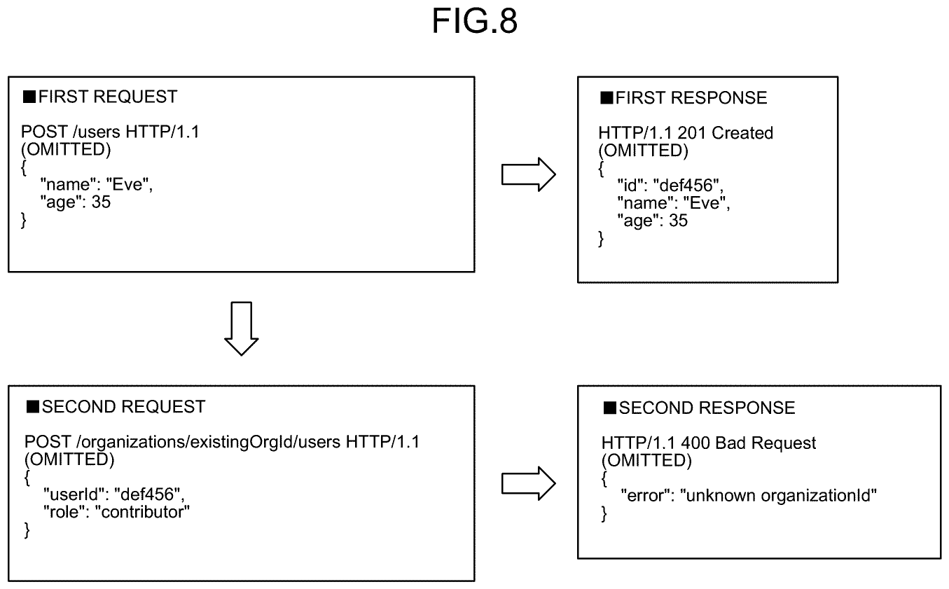

As in the case of the first candidate, the content of the first response is used for the second API call. An example of a series of requests and responses is as illustrated in FIG. 8.

FIG. 8 is a diagram illustrating Example 2 of a series of HTTP requests and responses according to the first embodiment. The second request fails with a status code 400. The reason is that the character string “existingOrgId” specified as the identifier of the organization is an identifier that does not exist in the actual system. From this, the determination unit 102 determines that the request in FIG. 8 is not a normal-system API call method, and tries the next candidate in FIG. 5. The next candidate consists of the following three API calls:

•First time
•Method: POST
•Path: /organizations
•Parameters:
{
“name”: “My Organization”
}
•Second time
•Method: POST
•Path: /users
•Parameters:
{
“name”: “John”,
“age”: 30,
}
•Third time
•Method: POST
•Path: /organizations/{{0.id}/users
•Parameters:
{
“userId”: “{{1.id}}”,
“role”: “member”
}

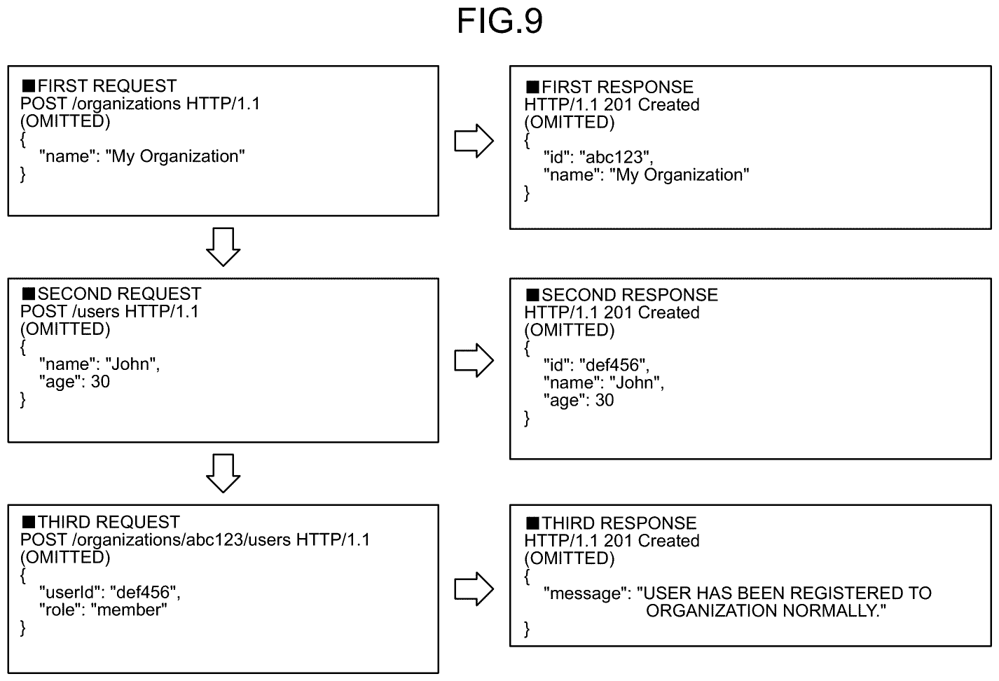

In the third API call, the contents of the first response and the second response are used as instructed in the prompt. The id portion of the first response is used as the {{0.id}} portion of the path. The id portion of the second response is used as the {{1.id}} portion of the parameter. The determination unit 102 constructs a body part of the third HTTP request from the first response and the second response. An example of a series of requests and responses is as illustrated in FIG. 9.

FIG. 9 is a diagram illustrating Example 3 of a series of HTTP requests and responses according to the first embodiment. The last (third) request succeeds with the status code 201. The determination unit 102 determines that FIG. 9 is the normal-system API call method based on the fact that the status code of success is obtained. The determination of the specification related to the third API ends.

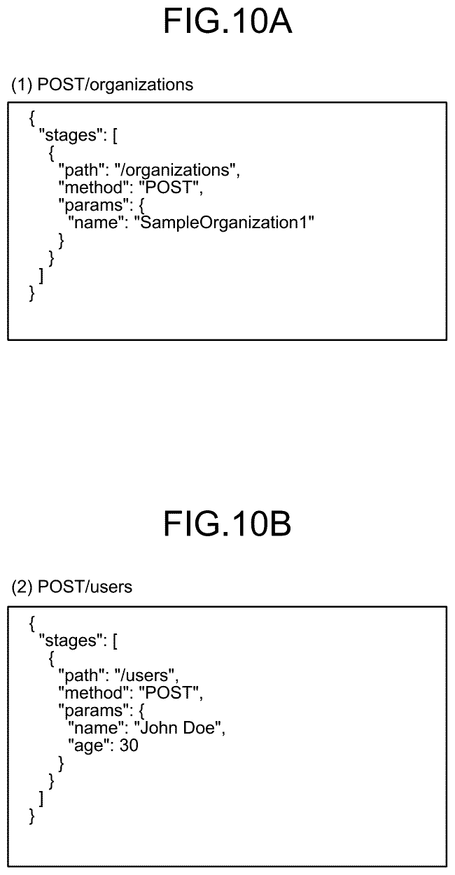

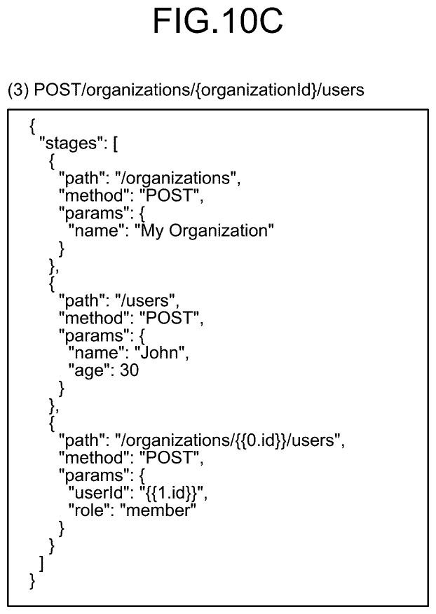

The determination unit 102 passes, to the correction unit 105, the specifications determined in the above procedure (the method of calling the API to become a normal system: FIGS. 10A to 10C).

FIG. 10A is a diagram illustrating Example 1 of a method of calling an API to be a normal system according to the first embodiment. FIG. 10B is a diagram illustrating Example 2 of a method of calling an API to be a normal system according to the first embodiment. FIG. 10C is a diagram illustrating Example 3 of a method of calling an API to be a normal system according to the first embodiment. The correction unit 105 displays the specification determined by the determination unit 102 (for example, FIGS. 10A to 10C) on a display device or the like, and causes a user (for example, an API developer) of the information processing apparatus 1 to check whether or not the specification determined by the determination unit 102 has content as expected. When the user inputs the correction information via the input device or the like in a case where the specification is different from the expectation, the specification determined by the determination unit 102 is corrected by the correction information.

Next, the determination unit 102 passes the specification finally specified by the above procedure to the transmission control unit 106, and requests transmission of the learning data. The transmission control unit 106 transmits the learning data to the specification interpretation device 2 via the communication IF 20.

The specification interpretation device 2 trains which candidate is a correct API call method by using the learning data, and uses it for accuracy improvement in the next and subsequent times.

The determination unit 102 inputs the specifications determined in the above procedure (the method of calling the API to become a normal system: FIGS. 10A to 10C) to the generation unit 104 and requests generation of the test scenario 12.

The generation unit 104 generates the test scenario 12 based on the specification determined by the determination unit 102. The generation unit 104 generates, as a test scenario of the normal system, a method of calling an API request in which a status code of success is included in a response to the API request. Then, the generation unit 104 generates a test scenario of an abnormal system based on the test scenario of the normal system. The scenario of the abnormal system test includes a test for verifying that incorrect parameter input is performed in various patterns for each parameter and a status code of failure is returned.

The test scenario 12 of the abnormal system includes, for example, the following tests.
It is checked that the status code 400 is obtained when the API is called without specifying the required parameter.
It is checked that the status code 400 is obtained when an invalid type is designated for the parameter and the API is called.

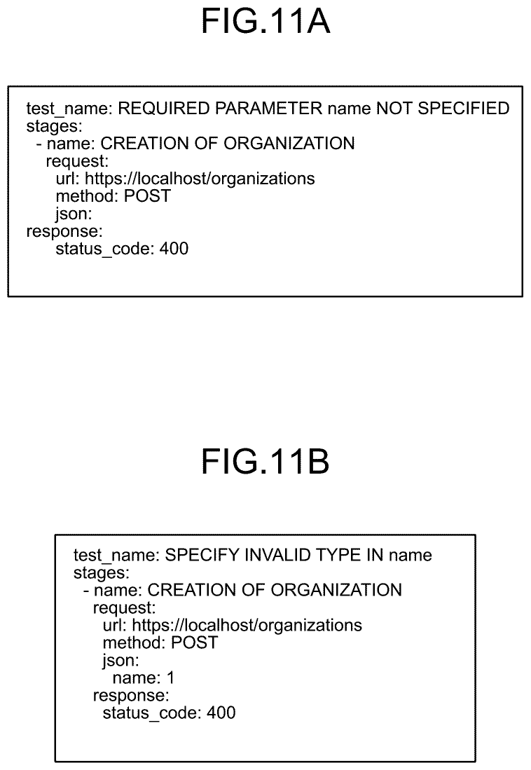

Each test scenario 12 is generated by rewriting designation of a specific parameter based on the call of the API of the normal system specified by the determination unit 102 (FIGS. 10A to 10C). FIGS. 11A and 11B illustrate examples of generation of scenarios of the two tests of the abnormal system in the first API (POST/organizations) in FIG. 2.

FIG. 11A is a diagram illustrating Example 1 of the test scenario 12 of an abnormal system according to the first embodiment. FIG. 11B is a diagram illustrating Example 2 of the test scenario 12 of an abnormal system according to the first embodiment. In the examples of FIGS. 11A and 11B, the test scenario 12 of the abnormal system is described in the format of tavern, which is a pytest-based test tool. In the test scenario 12 of FIG. 11A, it is checked that the status code 400 is returned when the API is called without specifying the required parameter name. In the test scenario 12 of FIG. 11B, it is confirmed that the status code 400 is returned when an invalid type (a numerical value type is designated where a character string type should be designated) is designated and the API is called.

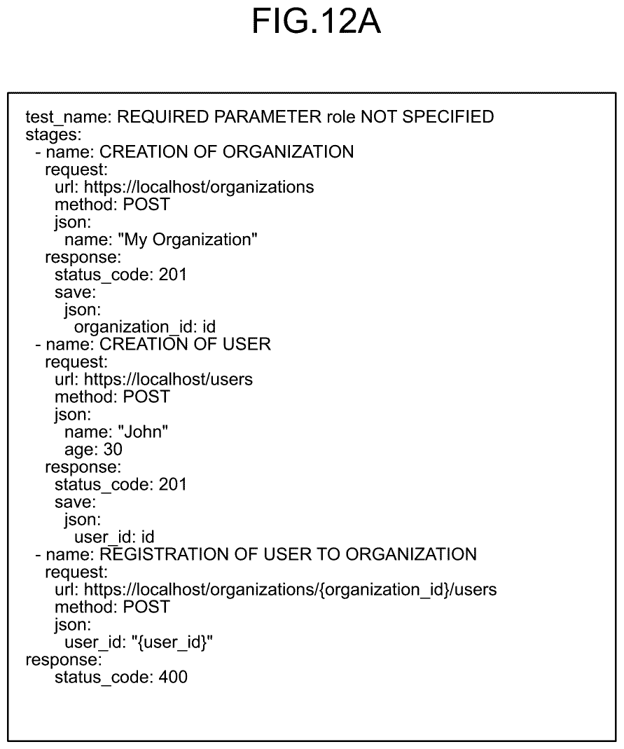

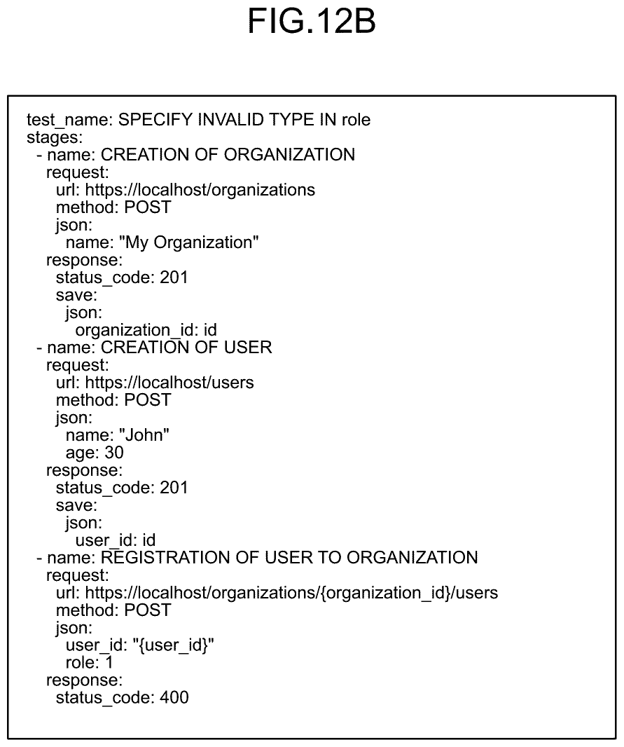

Also, FIGS. 12A and 12B illustrate examples of generation in the third API (POST/organizations/{organizationId}/users) in FIG. 2.

FIG. 12A is a diagram illustrating Example 3 of the test scenario 12 of an abnormal system according to the first embodiment. FIG. 12B is a diagram illustrating Example 4 of the test scenario 12 of an abnormal system according to the first embodiment. The examples of FIGS. 12A and 12B are test scenarios 12 for a purpose similar to that of the first API in FIG. 2. In FIGS. 12A and 12B, the manner of designating the parameter role is variously changed based on the content of FIG. 10C.

In the first embodiment, the two methods above for generating the test scenario 12 have been described. In addition, the test scenario 12 of the abnormal system described below may be generated.
Omission of authentication header including specification of password for enabling only specific user
Format (email, etc.) violation
Value other than option for enum
Invalid ID character string
Boundary value test for numerical parameters
Specify null value
Length boundary value test for character string parameters with length lower/upper limit

The generation unit 104 allows the user to download the generated test scenario 12 as a file. For example, the API developer can download the test scenario 12, execute a test tool (tavern in the first embodiment) on a terminal at hand, and execute a test according to the test scenario 12. The API developer can detect a defective operation of the API execution apparatus 3 under development by referring to the test result.

Note that there is a method of using the test scenario 12 other than causing the user to download. For example, the system may further include a test execution unit, and the processor 10 may pass the test scenario 12 to the test execution unit and request the test execution. Also in this case, the test execution unit presents the test execution result to the API developer as a report, so that the API developer can detect the defect of the API execution apparatus 3.

In the first embodiment, the test scenario 12 is automatically generated using the specification determined by the determination unit 102, but the determined specification may be used for other purposes. For example, the generation unit 104 may automatically generate a sample code indicating a use example of each API. By widely disclosing this sample code together with the API specification 11, it can be expected that the user of the API smoothly understands and learns the API use procedure. In addition, for example, the generation unit 104 may automatically generate a Try It Out page. The Try It Out page is an HTML page on which the API can be used for a trial. By configuring the page according to the determined specification, it is possible to encourage the user of the API to smoothly understand the usage procedure. Alternatively, the generation unit 104 may process the information corresponding to FIGS. 10A to 10C into a document in an HTML format and use the document as a manual of the API usage method. Then, the manual may be presented by a display device or the like.

An operation example when another API specification 11 different from that in FIG. 2 is input will be described below.

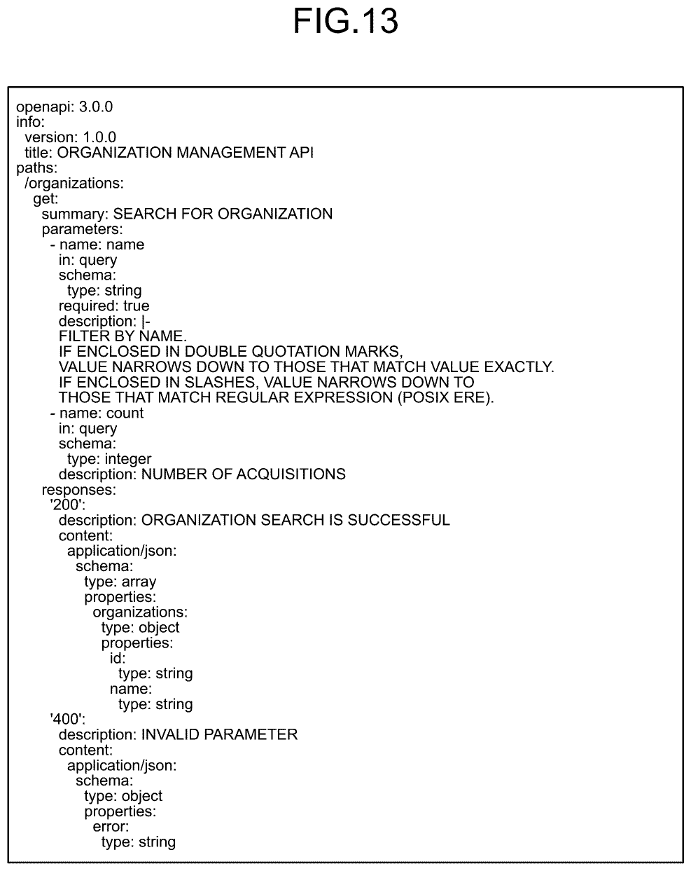

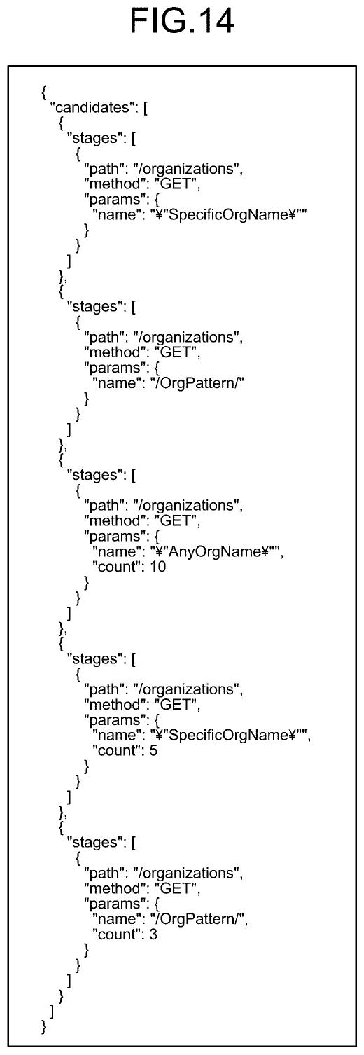

FIG. 13 is a diagram illustrating Example 2 of the API specification 11 according to the first embodiment. FIG. 14 illustrates a response example when a similar prompt regarding the API specification 11 of FIG. 13 is requested to the specification interpretation device 2.

FIG. 14 is a diagram illustrating Example 4 of a response to a prompt according to the first embodiment. When the request unit 101 inputs the response of FIG. 14 to the trial unit 103 and the trial unit 103 makes a trial, a status code of success in the first candidate is obtained in the case of FIG. 14.

•Method: GET
•Path: /organizations
•Parameters:
{
“name”: “\“SpecificOrgName\””
}

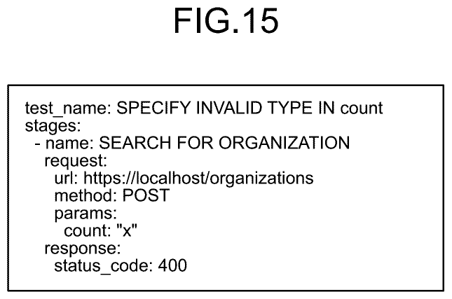

As a result, the method of calling the API that becomes the normal system is specified. The generation unit 104 generates the test scenario 12 of the abnormal system based on the method of calling the API to be the normal system. For example, the test scenario 12 when an invalid type is designated for the parameter count is as illustrated in FIG. 15.

FIG. 15 is a diagram illustrating Example 5 of the test scenario 12 of an abnormal system according to the first embodiment. In the test scenario 12 of FIG. 15, it is checked that the status code 400 is returned when an invalid type is designated for the parameter count and the API is called.

### Example of Information Processing Method

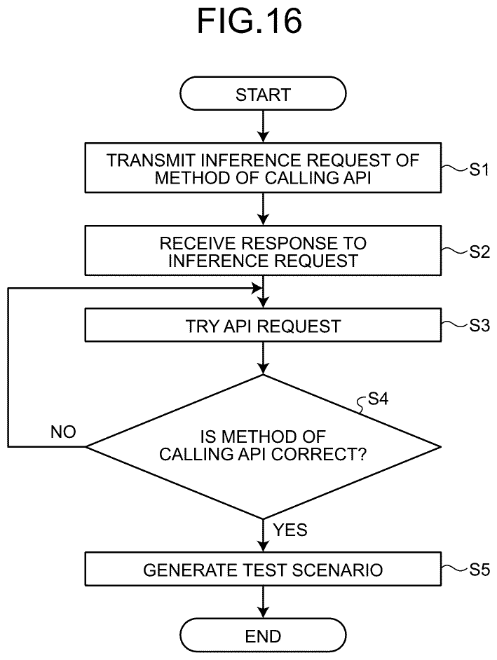

FIG. 16 is a flowchart illustrating an example of an information processing method according to the first embodiment. First, the communication IF 20 transmits an inference request of the method of calling the API included in the API specification 11 to the specification interpretation device 2 that interprets the API specification 11 by natural language processing (Step S1). Next, the communication IF 20 receives a response indicating the method of calling the API included in the API specification 11 from the specification interpretation device 2 (Step S2). Next, the processor 10 tries the API request by transmitting at least one API request to the API execution apparatus 3 based on the API call method candidate indicated by the response received in Step S2 (Step S3).

Next, the processor 10 determines whether the method of calling the API is correct based on the trial result of Step S3 (Step S4). For example, in a case where a status code of success is included in the response to the API request, the processor 10 determines that the method of calling the API indicated by the response in Step S2 is correct.

In a case where the method of calling the API is not correct (Step S4, No), the processing returns to Step S3, and an API request based on a next API call method candidate included in the response received in Step S2 is tried.

In a case where the API call method is correct (Step S4, Yes), the processor 10 generates the test scenario 12 based on the method of calling the API determined to be correct (Step S5). Note that the processor 2 may present to the user the method of calling the API determined to be correct, and may receive the correction information from the user as necessary before generating the test scenario 12.

As described above, in the information processing apparatus 1 of the first embodiment, the communication IF 20 transmits the inference request of the method of calling the API included in the API specification 11 to the specification interpretation device 2 that interprets the API specification 11 by natural language processing, and receives the response indicating the method of calling the API included in the API specification 11 from the specification interpretation device 2. Then, the processor 10 determines whether or not the method of calling the API indicated by the response is correct, and generates the test scenario 12 based on the method of calling the API indicated by the response in a case where the method of calling the API indicated by the response is correct.

As a result, according to the information processing apparatus 1 of the first embodiment, the test scenario 12 can be automatically generated more accurately from the API specification 11 using the natural language processing. Specifically, although there is a problem of uncertainty in utilizing the natural language processing technology, it is possible to generate the test scenario 12 (proper test scenario 12) as expected even if there is a possibility that a method of calling the API different from the intention of the creator of the API specification is inferred. As a result, for example, the API quality can be improved with less effort.

For example, the processor 10 can also specify a test item for checking an item not described in the API specification based on the response to the API request. As a result, the test scenario of the first embodiment can also include a test item for checking an item not described in the API specification.

### Second Embodiment

Next, a second embodiment will be described. In the description of the second embodiment, the description similar to that of the first embodiment will be omitted, and portions different from those of the first embodiment will be described.

In the second embodiment, as in the first embodiment, an example of generating a test scenario 12 for checking whether responses when various inputs are given are appropriate will be described. In the test scenario 12 of the second embodiment, it is checked that the API returns a status code of success when a valid input is made and returns a status code of failure when an invalid input is made. Further, at the time of failure, it is checked whether the content of the response body is as expected.

The second embodiment is different from the first embodiment in that generation of the test scenario 12 based on the method of calling the API obtained by inference is requested to the specification interpretation device 2 by a prompt, and a final test scenario 12 is generated after correction as necessary.

### Example of Functional Configuration

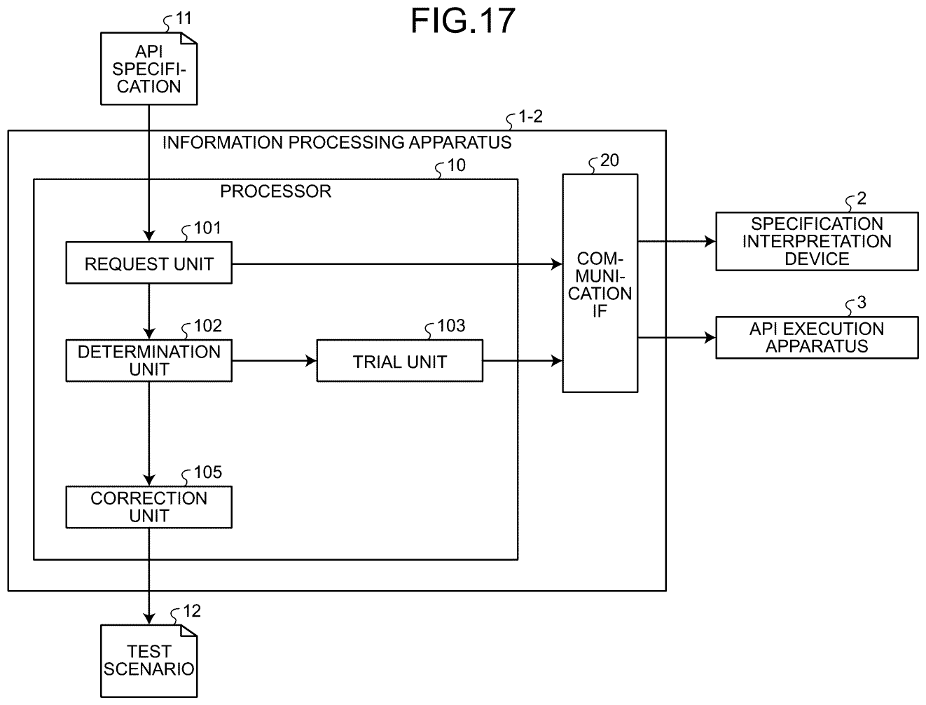

FIG. 17 is a diagram illustrating an example of a functional configuration of an information processing apparatus 1-2 according to the second embodiment. The information processing apparatus 1-2 according to the second embodiment includes a processor 10 and a communication IF 20. The processor 10 includes a request unit 101, a determination unit 102, a trial unit 103, and a correction unit 105.

The request unit 101 receives an input of the API specification 11, and requests the specification interpretation device 2 to infer the method of calling each API via the communication IF 20.

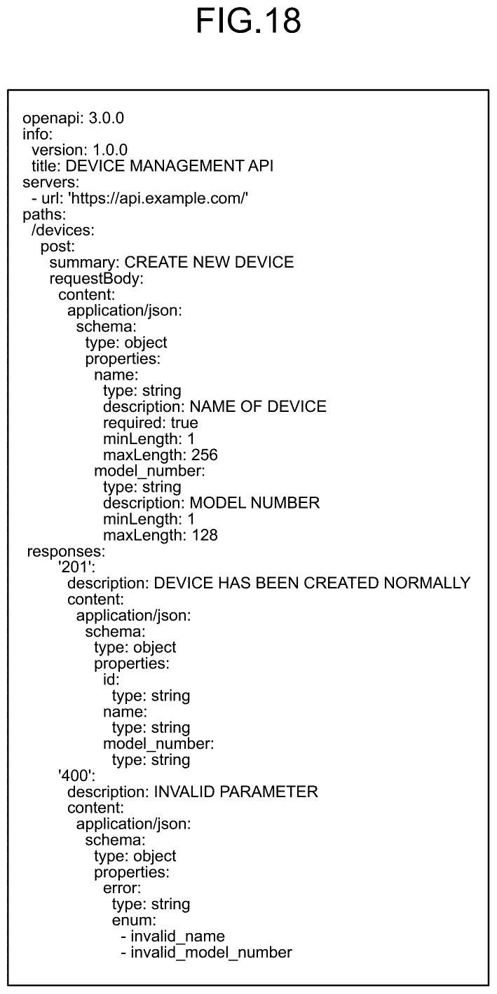

FIG. 18 is a diagram illustrating an example of the API specification 11 according to the second embodiment. In the example of FIG. 18, the following information is described as a specification in the OpenAPI format.

### Specification Example

```
  •Create new device
  endpoint: /devices
  method: POST
  request body:
  name (character string): The name of the device.
  model_number (character string): model number.
  response:
  status:
  201 Created
  400 Bad Request
  body (when succeeded):
  id (character string): Unique identifier of the
organization.
  name (character string): The name of the organization.
  model_number (character string): model number.
  body (when failed):
  error (character string): error content. invalid_name
or invalid_model_number.
```

Next, the usage intended by the creator of the API specification is as follows.

### Usage Example

The API is an API for creating a new device./devices sends a request to the endpoint by a POST method. In the request body, a name and a model number of a newly created device are specified as name and model number in a JSON format.

### Request Example

{
“name”: “Air conditioner 1”,
“model_number”: “RAS-N221”
}

When the processing is normally performed, information of the newly created organization is returned as a response together with a status code 201.

### Response Example

{
“id”: “abc123”,
“name”: “Air conditioner 1”,
“model_number”: “RAS-N221”
}

If an inappropriate parameter is specified, an error content is returned along with a status code 400. In the error content, invalid_name is written when an inappropriate value is specified for name, and invalid_model_number is written when an inappropriate value is specified for model_number.

{
“error”: “invalid_name”
}

When receiving the API specification 11 as an input, the processor 10 generates the test scenario 12 by the following procedure. First, the request unit 101 passes the API specification 11 to the specification interpretation device 2 and requests the specification interpretation device 2 to infer the method of calling the API. The following is an example of a prompt generated by the request unit 101.

### Example of Prompt

The following is a specification of Web API described in OpenAPI format. Generate a scenario file of tavern for testing the API execution apparatus implemented according to the use of the API. Generate tests indicated by the following test items. Output in strict compliance with the constraint conditions.

```
  # test item
  - Test for checking that a status code of success is
obtained.
  - Test for checking that an error occurs when an
invalid type is specified for each parameter of the API.
  - Test for checking that an error occurs when each
parameter to which the required flag is added is not
specified.
  - Test for checking that an error occurs when a
character string having a length exceeding the upper limit
is specified for each parameter in which the upper limit
and the lower limit of the character string length are
specified. Test for checking that an error occurs when a
character string having a length less than the lower limit
is specified.
  # constraint condition
  - Never output text other than the scenario file of
tavern.
  - In the test for checking that an error occurs,
further checking that the status code and the body content
of the response are as expected.
  # Web API Specification
  openapi: 3.0.0
  info:
  (The following is omitted since it is the same content
as that in Fig. 18.)
```

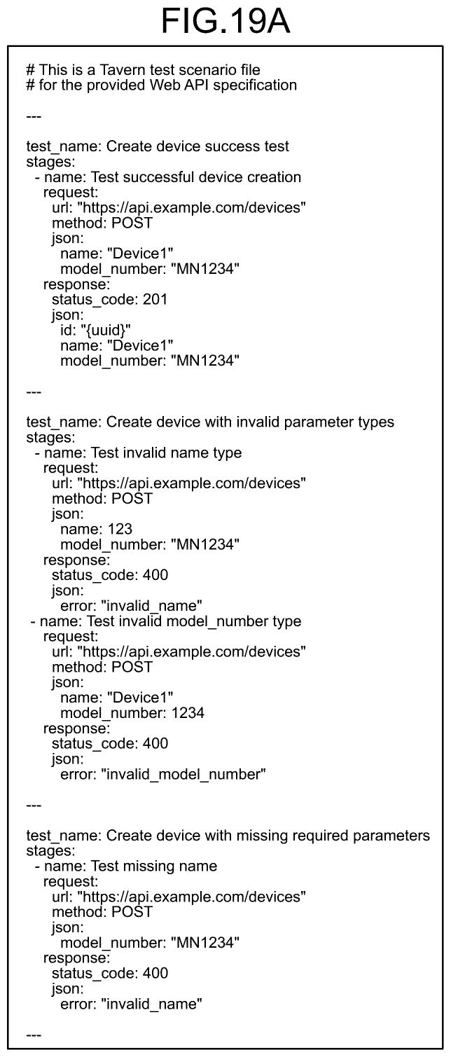

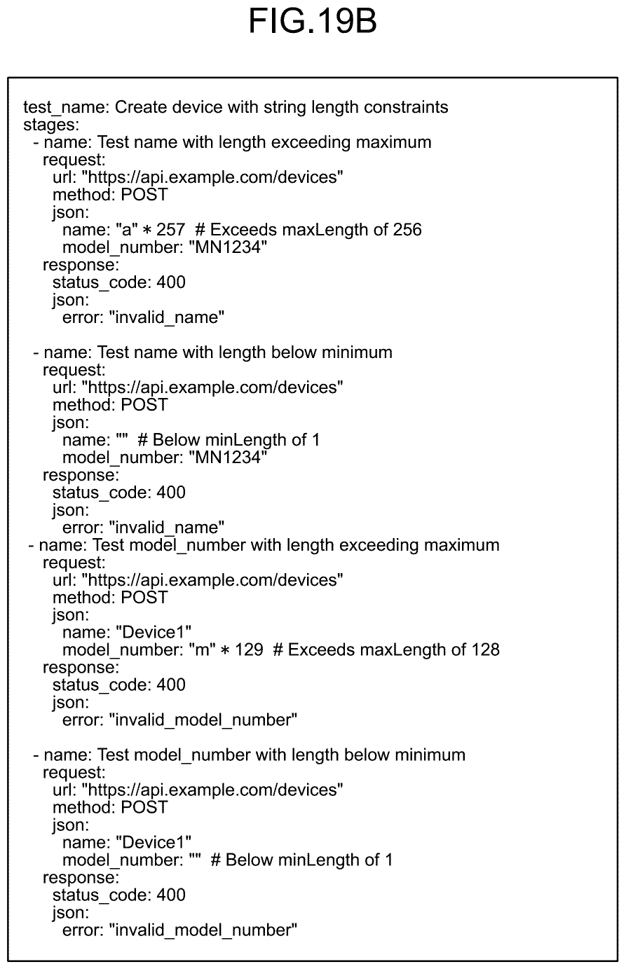

The specification interpretation device 2 returns the test scenario 12 based on the method of calling the API as a response to the prompt. Examples of the response are illustrated in FIGS. 19A and 19B.

FIGS. 19A and 19B are diagrams illustrating examples of responses to a prompt according to the second embodiment. In the test scenario 12 of FIGS. 19A and 19B, a test of an abnormal system is also described in addition to a test of a normal system.

In the abnormal system test, it is checked that the status code 400 is obtained when an invalid value of various patterns (instructed by a prompt) is specified for each parameter, and that error content of a response body includes a name of a parameter. That the error content of the response body includes the name of the parameter means that, for example, when an invalid value is designated for name, error of the response body becomes invalid name.

The content of the response body of the abnormal system test is not directly described in the API specification 11, and the specification interpretation device 2 infers this point from the API specification 11 and includes the content of the response body of the abnormal system test in the test scenario 12.

Referring back to FIG. 17, the request unit 101 requests the determination unit 102 to determine the method of calling the API by inputting the test scenario 12 (tavern format) obtained by the response from the specification interpretation device 2.

The determination unit 102 determines that the specification interpretation indicated by the test scenario 12 input from the request unit 101 is a correct API call method when the test scenario 12 is actually executed and the test is successful. Specifically, the determination unit 102 passes the test scenario 12 to the trial unit 103 and requests execution of a test. The trial unit 103 performs a test and generates a test result report by transmitting an API request to the API execution apparatus 3 according to the test scenario 12.

When the test ends, the determination unit 102 passes the test scenario 12 and the test result report generated by the trial unit 103 to the correction unit 105.

The correction unit 105 displays the test scenario 12 and the test result report on a display device or the like, and causes the user (for example, an API developer) of the information processing apparatus 1-2 to check whether the determined specification has contents as expected. In particular, for the test scenario 12 in which the actual test execution result was a failure, the user checks whether the content of the test scenario 12 is as intended, and if it is different from the intention, inputs the correction content of the test scenario 12.

When the checking by the user ends, the correction unit 105 outputs the final test scenario 12, and the processing of the processor 10 ends.

### Example of Information Processing Method

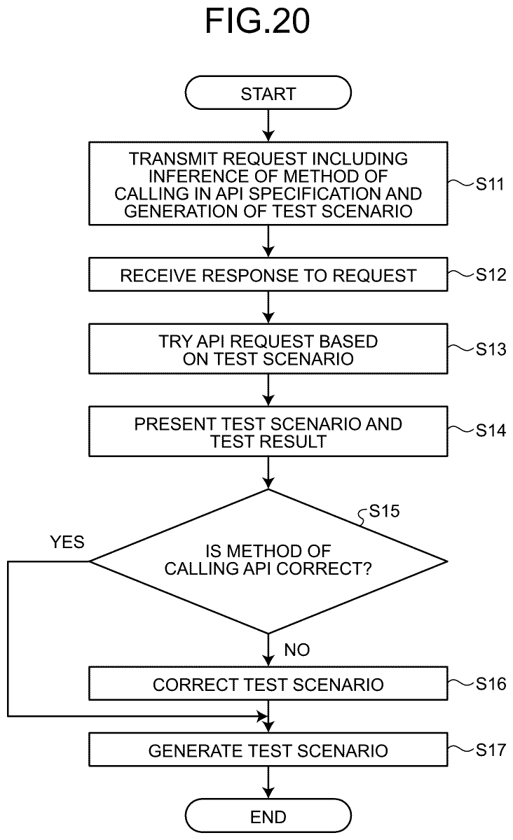

FIG. 20 is a flowchart illustrating an example of an information processing method according to the second embodiment. First, the communication IF 20 transmits a request including the inference of the method of calling the API included in the API specification 11 and the generation of the test scenario to the specification interpretation device 2 (Step S11). Next, the communication IF 20 receives a response including a test scenario based on the method of calling the API included in the API specification 11 from the specification interpretation device 2 (Step S12). Next, the processor 10 tries the API request by transmitting at least one API request to the API execution apparatus 3 based on the test scenario indicated by the response received in Step S12 (Step S13).

Next, the correction unit 105 presents the test scenario and the test result to the user by a display device or the like (Step S14).

Next, the processor 10 determines whether the method of calling the API (test scenario based on the method of calling the API obtained as the inference result) is correct based on the trial result of Step S13 (Step S15). For example, in a case where the test is successful, that is, in a case where an expected result is obtained in the test of the normal system or the abnormal system, the processor 10 determines that the method of calling the API indicated by the response in Step S12 is correct.

In a case where the method of calling the API is not correct (Step S15, No), the processor 10 receives an input of correction information for correcting the test scenario from the user via the input device (Step S16).

In a case where the method of calling the API is correct (Step S15, Yes), the processor 10 generates the final test scenario 12 by performing conversion into a predetermined data format or the like (Step S17).

Note that the correction of the test scenario may be performed not only in a case where the method of calling the API is incorrect, but also in a test scenario in which the method of calling the API is determined to be correct. For example, for the test scenario in which the method of calling the API is determined to be correct, a correction such as further increasing the variation (for example, a test item for testing a range of parameter values (such as an upper limit and a lower limit)) of the test item may be performed.

Finally, an example of a hardware configuration of the information processing apparatus 1 (1-2) according to the first and second embodiments will be described.

### Example of Hardware Configuration

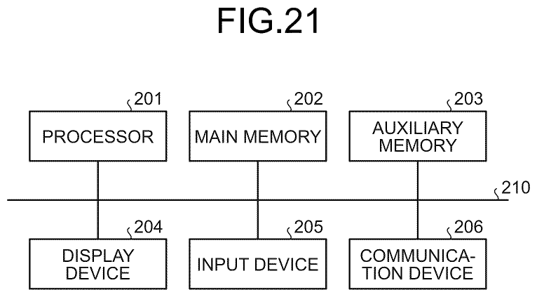

FIG. 21 is a diagram illustrating an example of a hardware configuration of the information processing apparatus 1 (1-2) according to the first and second embodiments. The information processing apparatus 1 (1-2) according to the first and second embodiments includes a processor 201, a main memory 202, an auxiliary memory 203, a display device 204, an input device 205, and a communication device 206. The processor 201, the main memory 202, the auxiliary memory 203, the display device 204, the input device 205, and the communication device 206 are connected via a bus 210.

Note that the information processing apparatus 1 (1-2) may not include a part of the above configuration. For example, in a case where the information processing apparatus 1 (1-2) can use an input function and a display function of an external device, the information processing apparatus 1 (1-2) may not include the display device 204 and the input device 205.

The processor 201 executes a program read from the auxiliary memory 203 to the main memory 202. The main memory 202 is a memory such as a ROM and a RAM. The auxiliary memory 203 is a hard disk drive (HDD), a memory card, or the like.

The display device 204 is, for example, a liquid crystal display or the like. The input device 205 is an interface for operating the information processing apparatus 1. Note that the display device 204 and the input device 205 may be implemented by a touch panel or the like having a display function and an input function. The communication device 206 is an interface for communicating with other devices.

For example, the program executed by the information processing apparatus 1 (1-2) is a file in an installable format or an executable format, is recorded in a computer-readable storage medium such as a memory card, a hard disk, a CD-RW, a CD-ROM, a CD-R, a DVD-RAM, and a DVD-R, and is provided as a computer program product.

Furthermore, for example, the program executed by the information processing apparatus 1 (1-2) may be stored on a computer connected to a network such as the Internet and provided by being downloaded via the network.

Furthermore, for example, the program executed by the information processing apparatus 1 (1-2) may be provided via a network such as the Internet without being downloaded. Specifically, the information processing may be executed by a so-called application service provider (ASP) type service that implements a processing function only by an execution instruction and result acquisition without transferring the program from the server computer.

Furthermore, for example, the program of the information processing apparatus 1 (1-2) may be provided by being incorporated in a ROM or the like in advance.

The program executed by the information processing apparatus 1 (1-2) has a module configuration including functions that can be implemented by the program among the above-described functional configurations. As actual hardware, the processor 201 reads a program from a storage medium and executes the program, whereby the functional blocks are loaded on the main memory 202. That is, the functional blocks are generated on the main memory 202.

Note that some or all of the above-described functions may not be implemented by software but may be implemented by hardware such as an integrated circuit (IC).

In addition, each function may be implemented using a plurality of processors 201, and in this case, each processor 201 may implement one of the functions or may implement two or more of the functions.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

### Supplement

The above embodiments may be summarized into the following Technical Ideas.

### Technical Idea 1

An information processing apparatus including:
a communication interface configured to transmit an inference request of a method of calling an application programming interface (API) included in an API specification, to a specification interpretation device that interprets the API specification by natural language processing, and receive a response indicating the method of calling the API included in the API specification from the specification interpretation device; and
a processor configured to determine whether or not the method of calling the API indicated by the response is correct, and generate a test scenario based on the method of calling the API indicated by the response if the method of calling the API indicated by the response is correct.

### Technical Idea 2

The information processing apparatus according to Technical Idea 1, in which
the communication interface is configured to transmit at least one API request to an API execution apparatus, based on the method of calling the API indicated by the response, and
the processor is configured to determine that the method of calling the API indicated by the response is correct if a status code of success is included in the response of the API request.

### Technical Idea 3

The information processing apparatus according to Technical Idea 2, in which
the processor is configured to generate, as the test scenario of the normal system, a method of calling the API request in which a status code of success is included in a response of the API request, and generate the test scenario of the abnormal system based on the test scenario of the normal system.

### Technical Idea 4

The information processing apparatus according to Technical Idea 2, in which
the processor is configured to also specify a test item for checking an item not described in the API specification, based on the response to the API request, and
the test scenario includes a test item for checking an item not described in the API specification.

### Technical Idea 5

The information processing apparatus according to any one of Technical Ideas 1 to 4, in which
the inference request includes a presentation request of a plurality of candidates indicating the method of calling the API.

### Technical Idea 6

The information processing apparatus according to any one of Technical Ideas 1 to 4, in which
the processor is configured to display, on a display device, information indicating the method of calling the API determined to be correct, and correct the method of calling the API, based on correction information input by a user.

### Technical Idea 7

The information processing apparatus according to any one of Technical Ideas 1 to 4, in which
the communication interface is configured to transmit, to the specification interpretation device, learning data including information indicating the method of calling the API determined to be correct.

### Technical Idea 8

An information processing method including:
transmitting an inference request of a method of calling an application programming interface (API) included in API specification, to a specification interpretation device that interprets the API specification by natural language processing, and receiving a response indicating the method of calling the API included in the API specification from the specification interpretation device, by an information processing apparatus; and
determining whether or not the method of calling the API indicated by the response is correct, and generating a test scenario based on the method of calling the API indicated by the response if the method of calling the API indicated by the response is correct, by the information processing apparatus.

### Technical Idea 9

A computer program product comprising a non-transitory computer-readable medium including programmed instructions, the instructions causing a computer to execute:
transmitting an inference request of a method of calling an application programming interface (API) included in an API specification, to a specification interpretation device that interprets the API specification by natural language processing, and receiving a response indicating the method of calling the API included in the API specification from the specification interpretation device; and
determining whether or not the method of calling the API indicated by the response is correct, and generating a test scenario based on the method of calling the API indicated by the response if the method of calling the API indicated by the response is correct.

What is claimed is:

1. An information processing apparatus comprising:
a communication interface configured to transmit an inference request of a method of calling an application programming interface (API) included in an API specification, to a specification interpretation device that interprets the API specification by natural language processing, and receive a response indicating the method of calling the API included in the API specification from the specification interpretation device; and
a processor configured to determine whether or not the method of calling the API indicated by the response is correct, and generate a test scenario based on the method of calling the API indicated by the response if the method of calling the API indicated by the response is correct.

2. The apparatus according to claim 1, wherein
the communication interface is configured to transmit at least one API request to an API execution apparatus, based on the method of calling the API indicated by the response, and
the processor is configured to determine that the method of calling the API indicated by the response is correct if a status code of success is included in the response of the API request.

3. The apparatus according to claim 2, wherein
the processor is configured to generate, as the test scenario of the normal system, a method of calling the API request in which a status code of success is included in a response of the API request, and generate the test scenario of the abnormal system based on the test scenario of the normal system.

4. The apparatus according to claim 2, wherein
the processor is configured to also specify a test item for checking an item not described in the API specification, based on the response to the API request, and
the test scenario includes a test item for checking an item not described in the API specification.

5. The apparatus according to claim 1, wherein
the inference request includes a presentation request of a plurality of candidates indicating the method of calling the API.

6. The apparatus according to claim 1, wherein
the processor is configured to display, on a display device, information indicating the method of calling the API determined to be correct, and correct the method of calling the API, based on correction information input by a user.

7. The apparatus according to claim 1, wherein
the communication interface is configured to transmit, to the specification interpretation device, learning data including information indicating the method of calling the API determined to be correct.

8. An information processing method comprising:
transmitting an inference request of a method of calling an application programming interface (API) included in an API specification, to a specification interpretation device that interprets the API specification by natural language processing, and receiving a response indicating the method of calling the API included in the API specification from the specification interpretation device, by an information processing apparatus; and
determining whether or not the method of calling the API indicated by the response is correct, and generating a test scenario based on the method of calling the API indicated by the response if the method of calling the API indicated by the response is correct, by the information processing apparatus.

9. A computer program product comprising a non-transitory computer-readable medium including programmed instructions, the instructions causing a computer to execute:
transmitting an inference request of a method of calling an application programming interface (API) included in an API specification, to a specification interpretation device that interprets the API specification by natural language processing, and receiving a response indicating the method of calling the API included in the API specification from the specification interpretation device; and
determining whether or not the method of calling the API indicated by the response is correct, and generating a test scenario based on the method of calling the API indicated by the response if the method of calling the API indicated by the response is correct.
